(19) United States
(12) Patent Application Publication
(10) Pub. No.: US 2026/0275718 A1
(43) Pub. Date: Sep. 17, 2026

(54) CONSTRUCTION BOARD ASSEMBLY WITH INTEGRATED INSULATION FOR REDUCED THERMAL BRIDGING

(71) Applicants: Bobby Todd Wright, Orlando, FL (US); Todd Stephen Ellis, Orlando, FL (US)

(72) Inventors: Bobby Todd Wright, Orlando, FL (US); Todd Stephen Ellis, Orlando, FL (US)

(21) Appl. No.: 19/563,565

(22) Filed: Mar. 11, 2026

Related U.S. Application Data
(60) Provisional application No. 63/769,896, filed on Mar. 11, 2025.

(51) Int. Cl. E04C 2/288; B32B 5/18; B32B 7/12; B32B 9/04

(52) U.S. Cl. CPC E04C 2/288; B32B 5/18; B32B 7/12; B32B 9/046; B32B 2250/02; B32B 2266/08; B32B 2307/304; B32B 2307/72; B32B 2607/00

(57) ABSTRACT

A construction board assembly includes a thermal insulation board and a construction board including magnesium oxide. The construction board and the thermal insulation board are bonded together with an adhesive. The construction board assembly is transportable and installable as a single unit. The construction board assembly has two flat and continuous sides, either of which can be mounted to structural framing members or exposed as a finish surface. The construction board assembly has a continuous thermal break to reduce thermal bridging and enhance energy efficiency. The construction board assembly can be used in various structures, such as walls, floors, and ceilings, to simplify construction and improve building performance.

### CROSS-REFERENCE TO RELATED APPLICATION

This application claims priority to U.S. Provisional Patent Application No. 63/769,896, filed on Mar. 11, 2025, and titled COMPOSITE WALL PANEL FOR REDUCED THERMAL BRIDGING, the entire content and disclosure of which is incorporated by reference in its entirety.

### FIELD

The field of the disclosure relates generally to construction board assemblies and, more particularly, to a construction board assembly including a continuous insulation layer to reduce thermal bridging.

### BACKGROUND

The construction industry has long struggled with the issue of thermal bridging, which occurs when there is a direct heat transfer path between the interior and exterior of a building, resulting in energy losses and reduced building efficiency. Various approaches have been taken to address this issue, including the use of multiple insulation layers and specialized materials. For instance, some builders have utilized multi-component systems featuring multiple layers of insulation assembled with protective materials like plywood or oriented strand board (OSB) and secured together with fasteners or other materials. However, these multi-component systems are complex and costly to install because they require significant labor and material resources, and can be prone to failure at connection points between the separate materials. Additionally, these or other systems may not provide a continuous thermal break, as mechanical fasteners or other heat-conductive components of the systems can create thermal bridges that compromise the overall energy efficiency of the building. In addition, the multi-component systems may not meet current building code requirements or be appropriate for use in different applications. Moreover, mechanical fasteners cause thousands of holes in a building envelope, which can facilitate the intrusion of air and water vapor.

Therefore, there is a need for a construction board assembly that reduces thermal bridging, reduces labor, and facilitates sealing the building envelope, while being customizable and cost-feasible.

### BRIEF DESCRIPTION

In some aspects, a construction board assembly generally includes a construction board, a thermal insulation board, and an adhesive. The construction board includes magnesium oxide and has a first face and a second face. The first face of the construction board defines a first uncovered side of the construction board assembly. The thermal insulation board has a first face and a second face. The second face of the thermal insulation board defines a second uncovered side of the construction board assembly. The thermal insulation board includes a layer of foam insulation having a uniform thickness. The adhesive is between the construction board and the thermal insulation board and bonds the first face of the thermal insulation board to the second face of the construction board. The construction board assembly is transportable as a single unit and is configured to attach to structural framing members with the first uncovered side or the second uncovered side facing the structural framing members. The first uncovered side and the second uncovered side are flat and continuous and are arranged to mount to the structural framing members or be exposed as a finish surface.

In some aspects, a method of assembling a construction board assembly includes providing a construction board including magnesium oxide and including a first face and a second face. The first face of the construction board defines a first uncovered side of the construction board assembly. The method also includes providing a thermal insulation board having a first face and a second face. The second face of the thermal insulation board defines a second uncovered side of the construction board assembly. The thermal insulation board includes a layer of foam insulation having a uniform thickness. The method further includes depositing an adhesive on the second face of the construction board or the first face of the thermal insulation board, and positioning at least one of the construction board or the thermal insulation board such that the adhesive is between the construction board and the thermal insulation board. The adhesive bonds the first face of the thermal insulation board to the second face of the construction board to form the construction board assembly. The construction board assembly is transportable as a single unit and is configured to attach to structural framing members with the first uncovered side or the second uncovered side facing the structural framing members. The first uncovered side and the second uncovered side are flat and continuous and are arranged to mount to the structural framing members or be exposed as a finish surface.

In some aspects, a structure includes structural framing members and a construction board assembly attached to the structural framing members. The construction board assembly includes a construction board including magnesium oxide and having a first face and a second face. The first face of the construction board defines a first side of the construction board assembly. The construction board assembly also includes a thermal insulation board having a first face and a second face. The second face of the thermal insulation board defines a second side of the construction board assembly. The thermal insulation board includes a layer of foam insulation having a uniform thickness. The construction board assembly further includes an adhesive between the construction board and the thermal insulation board. The adhesive bonds the first face of the thermal insulation board to the second face of the construction board. The first side and the second side are flat and continuous and are arranged to mount to the structural framing members or be exposed as a finish surface. The first side of the construction board assembly or the second side of the construction board assembly is mounted directly to the structural framing members.

### BRIEF DESCRIPTION OF THE DRAWINGS

FIG. 1 is a perspective of a construction board assembly.

FIG. 2 is a side view of the construction board assembly.

FIG. 3 is a partially exploded perspective view of the construction board assembly.

FIG. 4 is a flow diagram of a method of assembling the construction board assembly.

FIG. 5 illustrates a structure incorporating the construction board assembly.

FIG. 6 illustrates an exploded view of an example of the wall of the structure including the construction board assembly.

FIG. 7 illustrates an exploded view of an example of an exterior wall, including the construction board assembly, with portions removed to illustrate interior components.

### DETAILED DESCRIPTION

Described are construction board assemblies that replace traditional multi-layered insulation systems and address thermal bridging in construction. Current systems often require separate layers of insulation and protective materials, such as plywood or oriented strand board (OSB), and/or use wall technologies which require mechanical fasteners. These methods can increase labor costs, waste, and construction time. Described construction board assemblies integrate the insulative and protective properties of, for example, foam insulation (e.g., expanded polystyrene (EPS), graphite polystyrene (GPS), and/or extruded polystyrene (XPS)) and magnesium oxide (MgO) into a single unit and reduce the number of materials and installation steps and labor. For example, MgO is incorporated into an outer protective board having structural, fire-resistant, and moisture-resistant characteristics, and foam insulation is provided in an inner insulative board having continuous insulation characteristics. The outer protective board is adhered to the inner insulative board to form a modular construction board assembly appropriate for use in a broad range of applications.

The construction board assembly offers a multitude of benefits and solves modern construction challenges. For example, the construction board assembly has continuous insulation, which is a requirement in modern building codes, such as in the American Society of Heating, Refrigerating, and Air-Conditioning Engineers (ASHRAE) 90.1 code. The continuous insulation provided by the construction board assembly effectively eliminates thermal bridging and enhances energy efficiency by creating an uninterrupted barrier against thermal transfer. The construction board assembly also boasts significant structural capacity and supports building loads while maintaining integrity. The construction board assembly is resistant to wind and impact and is suitable for use in areas prone to harsh weather conditions and hurricane zones. The impermeability of the construction board assembly provides moisture resistance, prevents water and air intrusion, and protects the building envelope without the need for additional building wraps or tape. Additionally, the construction board assembly includes MgO, which offers superior fire resistance and enhances safety by reducing the risk of fire spread. The construction board assembly is also resistant to pests, termites, insects, and microorganisms, provides long-term durability, and reduces maintenance. These features, combined with the streamlined installation process, result in substantial cost savings by minimizing labor and material expenses. Therefore, the construction board assembly is a cost-effective and versatile choice for various building applications.

The described construction board assemblies streamline the construction process, enhance energy efficiency, enhance structural integrity, provide an impermeable weather barrier, protect against fires and impact from wind-borne debris, and provide a cost-effective and time-saving alternative to traditional individual insulation, sheathing, and sealing systems and methods. In addition, the construction board assemblies reduce or eliminate potential failure points.

In an example, the construction board assembly has customizable dimensions selected to enhance performance and ease of installation for specific applications and to balance the insulative properties, structural strength, and ease of handling during construction of the construction board assembly, contributing to the panel's effectiveness in reducing thermal bridging while maintaining cost efficiency. For example, the magnesium oxide (MgO) layer, which forms the outer surface of the construction board assembly, can vary in thickness, with options including ⅛ inch (3.18 millimeters (mm)), ¼ inch (6.35 mm), ⅜ inch (9.53 mm), ½ inch (12.7 mm), ⅝ inch (15.88 mm), ¾ inch (19.05 mm), or 1 inch (25.4 mm). These thickness options provide flexibility in achieving the desired balance between structural integrity and fire resistance. The central foam insulation (e.g., expanded polystyrene (EPS), graphite polystyrene (GPS), and/or extruded polystyrene (XPS)) layer, serving as the primary insulative component, can also vary in thickness, with options including ½ inch (12.7 mm), ⅝ inch (15.88 mm), ¾ inch (19.05 mm), 1 inch (25.4 mm), 1 ½ inches (38.1 mm), or 2 inches (50.8 mm). This range of thicknesses allows for customization of the insulative properties of the construction board assembly to meet energy efficiency requirements. The overall dimensions of the construction board assembly can be standardized to 4 feet (1.22 meters) in width and 8 feet (2.44 meters) in length, such that the construction board assembly is compatible with common building practices and facilitates straightforward installation. In other examples, the construction board assembly may have different dimensions selected for specific applications. For example, the construction board assembly can have a length of 9 feet (2.74 meters), 10 feet (3.05 meters), or 12 feet (3.66 meters).

The manufacturing process for the construction board assembly involves several steps that simplify construction and provide for the improved performance characteristics of the construction board assembly. For example, first, an adhesive, such as an epoxy or a one-part moisture-cure urethane adhesive, is evenly applied to one side of a foam insulation (e.g., expanded polystyrene (EPS), graphite polystyrene (GPS), and/or extruded polystyrene (XPS)) board using roll coater equipment and/or a drip-type coater machine, with an example amount being approximately 12-14 grams per square foot. Next, a magnesium oxide (MgO) board is aligned and applied to the adhesive-coated side, ensuring the edges are properly aligned. A rough, unsanded side of the MgO board may be used to enhance adhesion. The construction board assemblies are then stacked and moved to a mechanical press, where controlled pressure, for example, a minimum of 3-5 pounds per square inch (psi) (20.7-34.5 kilopascals (kPa)), is applied. The construction board assemblies are positioned in the mechanical press and exposed to the pressure for a pre-selected time, e.g., at least one minute, to ensure secure bonding. After bonding, the construction board assemblies are inspected for quality and palletized for shipping, ready for distribution and installation.

An example installation of the construction board assembly starts by ensuring the installation site is clean. Then, the construction board assembly is positioned with the MgO side facing outward for fire-resistant and moisture-resistant properties. The construction board assembly is aligned with the building's framing, ensuring edges are flush with adjacent construction board assemblies to maintain a continuous insulating barrier. The construction board assembly is secured using appropriate fasteners, such as screws or nails, and/or adhesive, following the manufacturer's guidelines for spacing and depth to ensure structural integrity. The construction board assembly can also be attached to the wall or roof frame using alternative methods without mechanical fasteners, such as using adhesive insulation, wall capture systems, or any other suitable manner. Once installed, the construction board assemblies can be finished with direct-applied cladding or other exterior finishes, leveraging the MgO layer's suitability for such applications. This process simplifies construction and enhances energy efficiency by reducing thermal bridging.

In examples, the construction board assembly is provided as a pre-bonded, 2-in-1 integrated unit specifically engineered to accelerate the construction process and reduce on-site labor, material waste, and logistics costs by consolidating multiple installation phases into a single step. By combining the construction board and thermal insulation board into a single, transportable, and installable unit, the assembly minimizes the complexity of managing separate material streams and reduces the physical footprint of materials stored on-site.

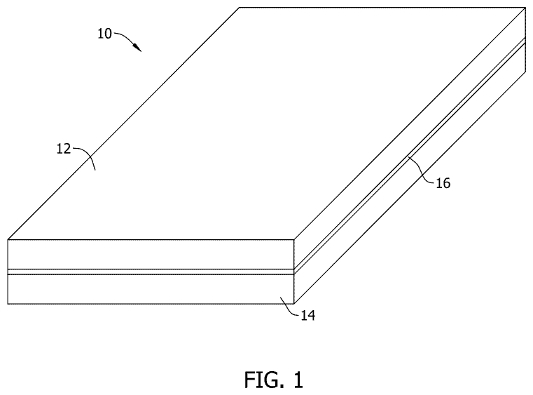

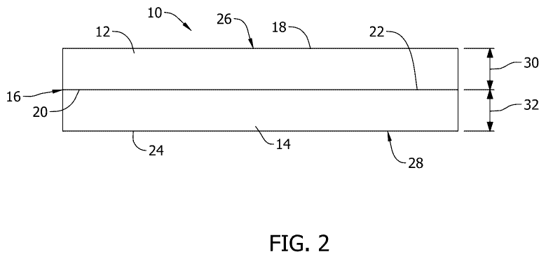

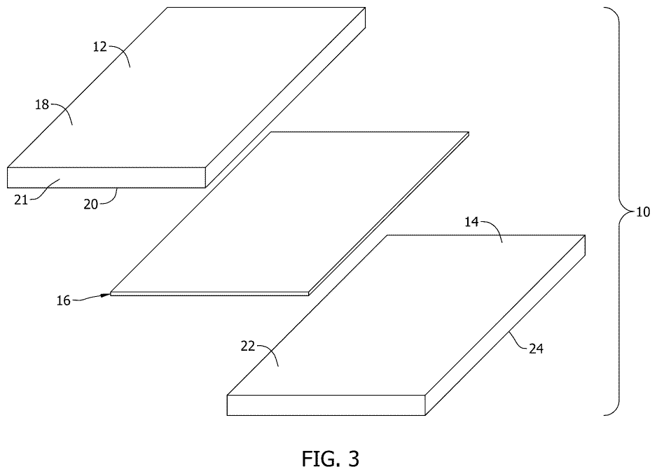

FIG. 1 illustrates a perspective view of a construction board assembly 10. FIG. 2 is a side view of the construction board assembly 10. FIG. 3 is a partially exploded perspective view of the construction board assembly 10. The construction board assembly 10 is modular and is configured to act as multiple components of a structure. For example, the construction board assembly 10 may be used as sheathing and has a structural load capacity to resist forces and provide structural support for a wall or floor of a building. In addition, the construction board assembly 10 may be used as a finished surface for interior or exterior walls, ceilings, or floors.

The construction board assembly 10 generally includes a construction board 12, a thermal insulation board 14, and an adhesive 16. The construction board 12 and thermal insulation board 14 form opposite, outer layers of the construction board assembly 10, and the adhesive 16 is sandwiched between the construction board 12 and the thermal insulation board 14. The configuration of the construction board assembly 10 provides a continuous insulative layer while maintaining structural integrity and fire resistance.

The construction board 12 includes a material that provides improved performance, such as magnesium oxide (MgO). For example, magnesium oxide enhances structural integrity, provides a surface suitable for direct-applied finish material, and contributes to the ability of the construction board 12 to resist nail and screw pullout. Additionally, the magnesium oxide in the construction board 12 offers superior fire resistance to reduce the risk of fire spread, is resistant to pests, termites, insects, and microorganisms, and is impermeable to moisture or vapor. In use, the construction board 12 with magnesium oxide has the strength to maintain the attachment of the construction board assembly 10 to the building structure and provide a surface to which fixtures and various types of finish material may be attached.

In the example, the construction board 12 is constructed as a single continuous and solid layer of the magnesium oxide. For example, the magnesium oxide of the construction board 12 has a density greater than 0.9 g/cm³ and is impermeable to moisture or vapor. The magnesium oxide is composed of inert, non-combustible materials. In some examples, the construction board 12 includes additional or different materials incorporated with or in place of the magnesium oxide. For example, the construction board 12 may include additives, such as silane, Iodopropynyl Butylcarbamate (IPBC), or borate.

The construction board 12 includes a first face 18, a second face 20, and lateral surfaces 21 extending between the first face 18 and the second face 20. The first face 18 and the second face 20 are each planar (i.e., lie in a single plane) and are parallel to each other. The lateral surfaces 21 are perpendicular to the first face 18 and the second face 20 and extend continuously on the perimeter of the first face 18 and the second face 20. The lateral surfaces 21 include four planar surfaces that meet at corners of the construction board 12 and define right angles at the corners. As a result, the construction board 12 is a rectangular cuboid. The shape of the construction board 12 facilitates the construction board assembly 10 being modular and compatible with a broad range of construction applications. In addition, the shape of the construction board 12 facilitates the construction board 12 matching and being joined to the thermal insulation board 14.

In this example, the first face 18 and the second face 20 feature different surface finishes. The first face 18 is treated (e.g., sanded or otherwise treated) and is smooth to facilitate use as an exposed surface to receive and retain direct-applied finish materials. The second face 20 is specifically prepared (e.g., textured or chemically treated) to enhance adhesion with the adhesive 16. For example, the second face 20 has a rough or abrasive surface that provides a higher coefficient of friction than the first face 18. In other examples, the first face 18 and the second face 20 may have similar surface finishes.

In some examples, the lateral surfaces 21 of the construction board 12 are not planar and are shaped to provide different edge formats to facilitate installation of the construction board assembly 10. For example, the lateral surfaces 21 can be shaped to accommodate tongue and groove joints, butt joints, spline joints, lap joints, or any other joints facilitating overlap or abutment between boards and reducing gaps or seams. For example, the lateral surfaces 21 may include a recessed area and a protruding section (e.g., a step) that corresponds to a complementary feature on an adjacent board, enabling a secure and flush connection between the boards. The shapes of the lateral surfaces 21 facilitate the creation of a continuous and cohesive surface, reduce the risk of water or air intrusion, and enhance the overall performance of the construction board assembly 10.

The construction board 12 has a thickness 30 defined between the first face 18 and the second face 20. The thickness 30 may be in a range of ¼ inch (6 mm) to ⅘ inch (20 mm), and/or the thickness 30 may be selected from standardized sizes including ⅛ inch (3.18 mm), ¼ inch (6.35 mm), ⅜ inch (9.53 mm), ½ inch (12.7 mm), ⅝ inch (15.88 mm), ¾ inch (19.05 mm), or 1 inch (25.4 mm). The thickness 30 is selected to provide a desired strength for the construction board 12 and/or for the construction board assembly 10 to fit a specified application (e.g., a desired wall thickness).

The thermal insulation board 14 functions as the primary insulative layer and significantly reduces or eliminates thermal bridging by providing a continuous barrier against thermal (heat/cold) transfer. The thermal insulation board 14 may comprise one or more layers of foam insulation, such as expanded polystyrene (EPS), extruded polystyrene (XPS), graphite polystyrene (GPS), polyisocyanurate (PIR), polyurethane (PU), phenolic foam, rigid fibrous insulation, spray foam insulation, cellular glass insulation, melamine foam, and/or graphite-expanded polystyrene (GPS), or alternatively or additionally, may comprise other insulative materials such as fiberglass batts, cellulose insulation, reflective insulation, rigid fiberglass panels, mineral wool insulation, ceramic fiber insulation, vacuum insulation panels, nanogel insulation, silica aerogel insulation, and/or radiant barrier insulation.

In examples, the thermal insulation board 14 is constructed of foam insulation. For example, the foam insulation is a closed-cell foam such as expanded polystyrene (EPS), graphite polystyrene (GPS), or extruded polystyrene (XPS). The foam insulation is lightweight yet effective in enhancing the overall thermal performance of the construction board assembly 10 and contributes to energy efficiency in building structures utilizing the construction board assembly 10. The properties of the foam insulation also offer protection against termites and other insects, as well as water and air vapor intrusion.

In some examples, the thermal insulation board 14 is constructed of one monolithic layer of foam insulation having a uniform thickness. In other examples, the thermal insulation board 14 includes two or more layers that are joined together, and each layer may or may not have the same thickness as other layers. Such a layered construction of the thermal insulation board 14 may facilitate customization of the properties of the construction board assembly 10.

The thermal insulation board 14 has a first face 22, a second face 24, and lateral surfaces 25 extending between the first face 22 and the second face 24. The first face 22 and the second face 24 are each planar (i.e., lie in a single plane) and are parallel to each other. In addition, the first face 22 and the second face 24 are free of any features, such as recesses or protrusions, and are flat across their entirety. The lateral surfaces 25 are perpendicular to the first face 22 and the second face 24 and extend continuously on the perimeter of the first face 22 and the second face 24. The lateral surfaces 25 include four planar surfaces that meet at corners of the thermal insulation board 14 and define right angles at the corners. As a result, the thermal insulation board 14 is a rectangular cuboid. The shape of the thermal insulation board 14 facilitates the construction board assembly 10 being modular and compatible with a broad range of construction applications. In addition, the shape of the thermal insulation board 14 facilitates the thermal insulation board 14 aligning with and being joined to the construction board 12.

The thermal insulation board 14 has a thickness 32 defined between the first face 22 and the second face 24. For example, the thickness 32 may be at least ¼ inch (6 mm). The thickness 32 may be selected from standardized sizes, including ½ inch (12.7 mm), ⅝ inch (15.88 mm), ¾ inch (19.05 mm), 1 inch (25.4 mm), 1 ½ inches (38.1 mm), or 2 inches (50.8 mm). The thickness 32 is selected to provide a desired insulation value for the thermal insulation board 14 and/or for the thermal insulation board 14 to fit a specified application (e.g., a desired wall thickness).

The thermal insulation board 14 may include an additive or be treated to provide preselected characteristics. For example, the thermal insulation board 14 is treated with 500 parts per million of Iodopropynyl Butylcarbamate (IPBC) and/or borate to provide fire-resistance and moisture-resistance properties. Examples of additives include fungicides such as chlorothalonil, copper-based compounds, and zinc-based compounds; insecticides such as pyrethroids, neem oil, and diatomaceous earth; flame retardants such as brominated compounds, phosphorus-based compounds, and magnesium hydroxide; water repellents such as silanes, siloxanes, and fluoropolymers; mold inhibitors such as zinc borate, sodium borate, and potassium borate; termite-resistant treatments such as borate-based treatments and permethrin-based treatments; rot-resistant treatments such as copper-based compounds and zinc-based compounds; algaecides such as copper-based compounds and zinc-based compounds; and preservatives such as IPBC, borate, and silane.

The adhesive 16 is positioned between and bonds the construction board 12 and the thermal insulation board 14. For example, the adhesive 16 bonds the first face 22 of the thermal insulation board 14 to the second face 20 of the construction board 12. The adhesive 16 forms a continuous and monolithic layer extending throughout the entire interface between the construction board 12 and the thermal insulation board 14. In the example, the adhesive 16 is a structural adhesive that ensures a strong connection and maintains the integrity of the construction board assembly 10 under various environmental conditions. The properties of the adhesive 16 have a structural capacity to handle loads and are selected to withstand thermal expansion and contraction and reduce delamination over time.

The adhesive 16 may include any material suitable to bond the construction board 12 to the thermal insulation board 14. For example, the adhesive 16 may include a low-volatile organic compound (low-VOC) or VOC-free adhesive selected to bond the construction board 12 and the thermal insulation board 14. In some examples, the adhesive 16 is a polymeric adhesive, which may include one or more of a urethane adhesive (e.g., a one-part moisture-cure urethane), an epoxy resin, an acrylic adhesive, a cyanoacrylate, a silicone, a polyvinyl acetate (PVA), or an ethylene-vinyl acetate (EVA). In other examples, the adhesive 16 may comprise a non-polymeric adhesive, such as a modified silane (MS) polymer, a cementitious adhesive, or an inorganic adhesive like sodium silicate. The adhesive 16 may be deposited in a liquid, molten, or semi-solid form and subsequently set or cured to form a permanent bond between the construction board 12 and the thermal insulation board 14.

In addition, optionally, the adhesive 16 includes at least one additive selected to modify a property of the adhesive. For example, the adhesive 16 includes an additive (or additives) that affects the thermal resistance, structural strength, fire resistance, pest or rodent resistance, and/or any other properties of the construction board assembly 10. Examples of additives include silane, Iodopropynyl Butylcarbamate (IPBC), borate, silica aerogel, graphite, carbon fibers, glass fibers, halogenated compounds, phosphorus-based compounds, permethrin, deltamethrin, brodifacoum, and bromadiolone.

The construction board assembly 10 includes a first side 26 and a second side 28. The first face 18 of the construction board 12 defines the first side 26 of the construction board assembly 10. The second face 24 of the thermal insulation board 14 defines the second side 28 of the construction board assembly 10. The first side 26 and the second side 28 are uncovered (e.g., free from paper or additional layers/coverings over the material faces). For example, the uncovered sides do not have a cover such as a paper sheet or film, and the material (MgO) for the construction board and the insulation for the thermal insulation board is exposed.

The construction board assembly 10 is transportable and able to be installed as a single unit. For example, the construction board 12 and the thermal insulation board 14 are laminated across their entire interface to define a monolithic flexural profile, and the construction board assembly 10 maintains a maximum deflection of less than L/360 when transported or installed as a single unit. Also, the adhesive 16 provides a peel strength sufficient to maintain the monolithic arrangement when fasteners are driven through the construction board 12 and/or the thermal insulation board 14 into structural framing members.

Also, the construction board assembly 10 is reversible because the construction board assembly 10 is configured to attach to structural framing members with the first (uncovered) side 26 or the second (uncovered) side 28 facing the structural framing members. Both the construction board 12 and the thermal insulation board 14 are configured to receive and retain a finish cladding fastener or sit flush against a framing member, depending on the orientation of the construction board assembly 10. Specifically, when the second side 28 faces the structural framing members, the thermal insulation board 14 can receive and retain a finish cladding fastener, and the construction board 12 can sit flush against a framing member. When the first side 26 faces the structural framing members, the construction board 12 can receive and retain a finish cladding fastener, and the thermal insulation board 14 can sit flush against a framing member. This reversibility is made possible at least in part by the flat and continuous nature of the first side 26 and the second side 28. For example, the first side 26 and the second side 28 are free of any features, such as recesses or protrusions, and are flat across their entirety, allowing for mounting to structural members or exposure as a finish surface.

As illustrated in FIGS. 1-3, the construction board 12, the thermal insulation board 14, and the adhesive 16 are arranged to emphasize the structural and insulative properties of the construction board assembly 10 and contribute to the effectiveness of the construction board assembly 10 in reducing thermal bridging. For example, the different materials are seamlessly integrated into a single composite structure that cannot be separated without damaging the materials. This facilitates the effectiveness of the construction board assembly 10 in reducing thermal bridging, simplifying construction, and enhancing energy efficiency.

As described above, the construction board assembly 10 is transportable and installable as a single unit and is reversible (e.g., configured to attach to structural framing members with the first uncovered side or the second uncovered side facing the structural framing members). Moreover, the construction board assembly 10 is preassembled (i.e., assembled at a location away from an installation site) in a modular state that can be transported and installed without modification or additional assembly.

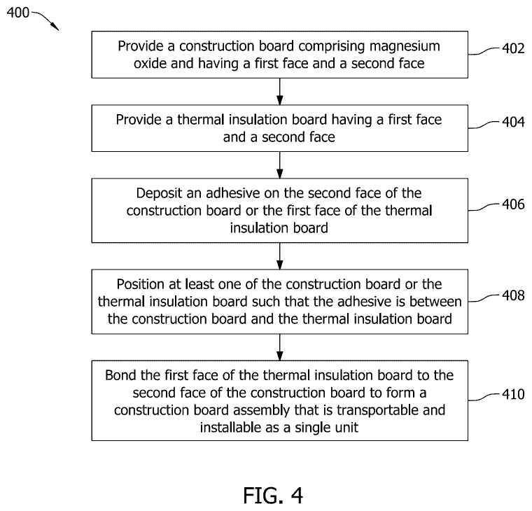

FIG. 4 is a flow diagram of a method 400 of assembling the construction board assembly 10 shown in FIGS. 1-3. Referring to FIGS. 1-4, the method 400 includes providing 402 a construction board (e.g., the construction board 12). The construction board 12 comprises magnesium oxide and includes a first face (e.g., the first face 18) and a second face (e.g., the second face 20). The first face of the construction board defines a first uncovered side (e.g., the first side 26) of the construction board assembly. In some examples, the construction board 12 may be cut or otherwise shaped from a larger sheet or block into desired dimensions.

The method 400 also includes providing 404 a thermal insulation board (e.g., the thermal insulation board 14) having a first face (e.g., the first face 22) and a second face (e.g., the second face 24). The second face of the thermal insulation board defines a second uncovered side (e.g., the second side 28) of the construction board assembly. The thermal insulation board comprises a monolithic layer of foam insulation having a uniform thickness. The thermal insulation board may be formed by spraying the foam insulation into a mold and curing or setting the foam insulation into a solid state. The foam insulation may then be cut from a larger sheet or block or otherwise formed to a desired size and shape.

The method 400 further includes depositing 406 an adhesive on at least one of the second face of the construction board or the first face of the thermal insulation board. The adhesive may be a liquid adhesive that is deposited in a liquid form and then set or cured to form a bond between the construction board and the thermal insulation board. The adhesive is applied to laminate the construction board and the thermal insulation board across their entire interface and form a monolithic flexural profile that maintains a maximum deflection of less than L/360 when transported as a single unit. In some examples, at least one additive is selected to modify a property of the adhesive and is distributed within the liquid adhesive prior to curing or setting of the liquid adhesive.

In some examples, the adhesive is deposited onto the construction board or the thermal insulation board such that the adhesive forms a continuous and monolithic layer extending throughout the entire interface between the construction board and the thermal insulation board. For example, a polymeric adhesive such as an epoxy resin or a one-part moisture-cure urethane adhesive is applied to the first face of the thermal insulation board using a roll coater and/or a drip-type coater equipment for even distribution. For example, the structural urethane adhesive may be applied onto the surface of the thermal insulation board at 12-14 grams per square foot (129-150 grams per square meter) or 2 grams per square foot (22 grams per square meter).

After the adhesive is applied, at least one of the construction board or the thermal insulation board is positioned 408 such that the adhesive is between the construction board and the thermal insulation board. For example, the construction board is moved relative to and applied to the adhesive-coated side of the thermal insulation board, ensuring the edges of the boards are aligned. The construction board and the thermal insulation board are positioned together with the adhesive between the construction board and the thermal insulation board such that the adhesive bonds the first face of the thermal insulation board to the second face of the construction board to form the construction board assembly.

After positioning the construction board relative to the thermal insulation board, in some examples, the method includes a quality control step of verifying the precise alignment of the lateral surfaces of both boards to ensure a flush, modular fit during installation. If misalignment is detected, the construction board and/or the thermal insulation board may be shifted to align the lateral surfaces of the boards and provide planar lateral surfaces of the construction board assembly. Following alignment, the construction board and the thermal insulation board are stacked and moved to a mechanical press where a desired pressure is applied to maintain and press the construction board and the thermal insulation board together. The assembly is maintained under constant compression within the mechanical press to ensure full polymerization of the structural adhesive 16 and to eliminate voids at the interface.

In some examples, the construction board assembly is subjected to a controlled curing process, where the construction board assembly is heated to a curing temperature of the adhesive, for example between 150° C. to 200° C., to achieve maximum strength and thermal stability. Uniform pressure is applied, via for example the mechanical press, during curing to enhance bonding and ensure a void-free structure. The curing process is carried out for a manufacturer-recommended time to achieve full polymerization. For example, the adhesive is cured or set under the controlled pressure (e.g., pressure with a range of 50 to 100 psi) for a minimum of 3-5 minutes to 10-15 minutes or more, depending on the specific adhesive and environmental conditions such as temperature and humidity. This cycle ensures full polymerization of a specialized structural low-VOC adhesive and eliminates microscopic voids at the interface to form a monolithic flexural profile with a minimum peel strength of, for example, 10 pounds per inch.

After curing, the construction board assembly may undergo post-curing treatment to further enhance properties of the construction board assembly. In some examples, the construction board assembly is heat-treated (e.g., exposed to a heating source for a predetermined time) to improve the epoxy's fire resistance and acoustic properties.

When complete, the adhesive bonds 410 the first face of the thermal insulation board to the second face of the construction board to form the construction board assembly that is transportable and installable as a single unit. The completed construction board assemblies are inspected for quality and palletized for shipping. A label or stamp may be added for identification.

After assembly, the construction board assembly is configured to be used in structures. The construction board assembly may be installed as a sheathing and attached to structural framing members with the first side or the second side facing the structural framing members. When installed as sheathing, the construction board assembly has a structural load capacity to resist forces and provides structural support for a wall, floor, or other component of a structure. In addition, the construction board and the thermal insulation board of the construction board assembly are configured to receive and retain a finish material fastener or to sit flush against a framing member.

Suitably, the construction board assembly is customizable to provide different characteristics. For example, additional material may be added between, on, or incorporated into the construction board, the thermal insulation board, and/or the adhesive to provide a desired characteristic. In some examples, the construction board assembly includes a built-in weather-resistant barrier (WRB) and/or a bulletproof material that is incorporated in at least one of the following locations: (1) into the construction board 12 or the thermal insulation board, (2) between the construction board and the thermal insulation board, (3) within the adhesive, or (4) on one or both of the outer surfaces of the construction board assembly.

In addition, the thickness of the construction board and/or the thermal insulation board may be adjusted to provide improved strength (e.g., thicker construction board) or improved insulating properties (thicker insulation). Alternatively or additionally, additional boards may be added to increase the thickness. Moreover, additives may be added to the construction board and/or the thermal insulation board during formation of the respective board(s).

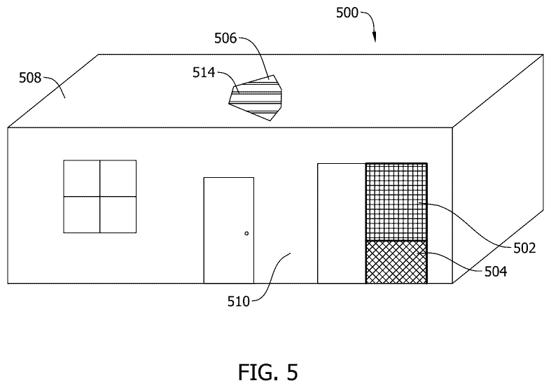

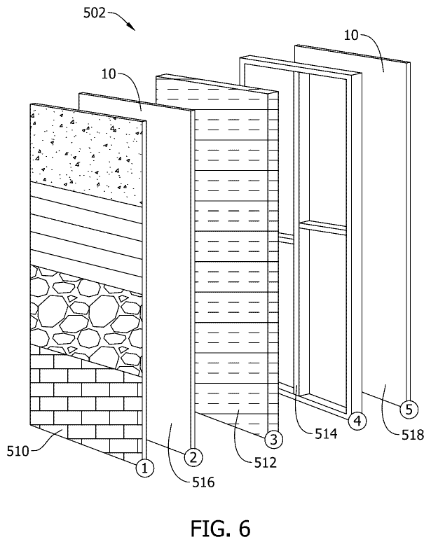

FIG. 5 illustrates a structure, e.g., a building, 500. FIG. 6 illustrates an exploded view of an example of a wall 502 of the structure 500, including the construction board assembly 10. The structure 500 includes components such as walls 502, floors 504, ceilings 506, a roof 508, cladding 510, insulation (shown in FIG. 6) 512, and structural framing members 514. In FIG. 5, portions of the structure 500 have been omitted to better illustrate the described components. For example, a portion of the roof 508 is omitted to reveal the structural framing members 514 and the ceiling 506.

Referring to FIGS. 1-5, the construction board assembly 10 shown in FIGS. 1-3 may be used in any components of the structure 500 shown in FIG. 5 to provide improved performance and simplify assembly of the structure 500. For example, the construction board assembly 10 may be used in the walls 502, the floors 504, the ceilings 506, and the roof 508. The construction board assembly 10 is directly mounted to the structural framing members 514 and may receive a cladding material or provide a finished surface for any of the walls 502, the floors 504, the ceilings 506, and the roof 508.

The construction board assembly 10 simplifies assembly of the structure 500 because the construction board assembly 10 is modular and includes multiple materials in a single unit. In addition, the construction board assembly 10 is simple to install and provides improved performance over other systems. Moreover, the construction board assembly 10 may be installed in different orientations based on the application or desired properties. For example, the construction board assembly 10 may be installed to present the construction board 12 as a finished surface when impact or wear resistance is required for the walls 502, the floors 504, the ceilings 506, or the roof 508. Alternatively, the construction board assembly 10 may be installed with the thermal insulation board 14 facing outward when appropriate for the application.

For example, the wall 502 includes cladding 510, insulation 512, and structural framing members 514. The construction board assembly 10 is incorporated into the wall 502 to provide improved performance capabilities and facilitate simple and quick construction of the wall 502. The construction board assembly 10, in a first configuration, forms exterior sheathing 516, and, in a second configuration, forms interior sheathing 518 of the wall 502. Suitably, the interior sheathing 518 directly receives a finish material (e.g., veneer, paint, or wallpaper), and the exterior sheathing 516 directly receives the cladding 510. In some examples, the cladding 510 is omitted, and the exterior sheathing 516 acts as a direct finish exterior material because of the properties of the construction board assembly 10.

The construction board assembly 10 acts as sheathing layers and provides improved insulation and strength to the wall 502 because of the properties of the construction board assembly 10. Also, the construction board assembly 10 provides a mounting surface for the cladding 510. The cladding 510 may be any suitable cladding (e.g., stucco, brick or stone veneer, siding) and is directly applied and attached to the construction board assembly 10. The construction board assembly 10 fully supports the cladding 510. In addition, the construction board assembly 10 provides a continuous thermal break because fasteners do not need to extend through the entire construction board assembly 10 to be supported, and the monolithic layer of foam insulation provides a continuous thermal insulation that increases the thermal resistance value (R) of the wall.

The construction board assembly 10 is directly attached to the structural framing members 514. Suitably, the construction board assembly 10 is reversible, and both a first side and a second side of the construction board assembly 10 are arranged to mount to the structural framing members 514 or be exposed as a finish surface. For example, both sides of the construction board assembly 10 are flat and continuous. The adhesive joins the construction board assembly 10 together with sufficient structural force for the construction board assembly 10 to act as a single structural member and resist delamination when forces are applied to individual layers. Either side is configured to sit flush against the structural framing members when the construction board assembly is attached to the structural framing members. In addition, both sides of the construction board assembly are configured to receive and retain a finish cladding fastener when the side faces away from the structural framing members 514.

The construction board assembly 10 is configured to directly attach to the structural framing members 514 and is compatible with different material types and reduces thermal bridging. Accordingly, the structural framing members 514 may be wood, light-gauge steel, and/or any suitable structural framing. The structural framing members 514 may define openings or conduits for utility services (e.g., pipes and wires).

The insulation 512 may be any suitable insulation. In the example, the insulation 512 includes closed-cell spray foam insulation that is positioned between and around the structural framing members 514. The insulation 512 adheres to the construction board assembly 10 and may at least partly attach the construction board assembly 10 to the structural framing members 514. In some examples, the insulation 512 is omitted because the construction board assembly 10 provides a sufficient thermal resistance due to the continuous thermal break.

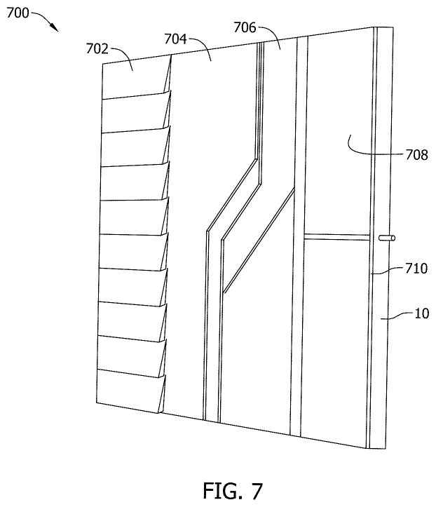

FIG. 7 illustrates an exploded view of an example of an exterior wall 700, including the construction board assembly 10, with portions removed to illustrate interior components. The exterior wall 700 includes exterior cladding 702, exterior sheathing 704, thermal insulation (e.g., closed-cell spray foam insulation) 706, optional acoustic insulation 708, structural framing members (e.g., light-gauge steel framing members) 710, and the construction board assembly 10.

For example, the construction board assembly 10, in a first configuration, forms a combination sheathing and sound barrier on an interior of the structure. The construction board assembly 10 is attached directly to the structural framing members 710.

As illustrated in FIG. 7, the construction board assembly 10 is configured for direct attachment to structural framing members 710, such as cold-formed steel or wood studs, in use in walls (or other components of a building) and the construction board assembly 10 is attached directly to the structural framing members 710 on both sides. In wall applications, the integration of the MgO board and the thermal insulation board serves as a continuous thermal break and significantly reduces heat transfer and increases the R-value of the wall. For example, the construction board assembly 10 has an R-value per inch of at least 4.

In some examples, the construction board assembly 10 provides a mounting surface for the finish material. The construction board assembly 10 fully supports the finish material. In addition, the construction board assembly 10 provides a continuous insulative break because fasteners do not need to extend through the entire construction board assembly 10 to be supported, and the thermal insulation board 14 provides a continuous insulation that increases the thermal resistance value and lowers sound transmittance through the floor 900.

In some examples, suitably, the construction board assembly 10 is reversible, and both a first side and a second side of the construction board assembly 10 are arranged to mount to the structural framing members 710. For example, both sides of the construction board assembly 10 are flat and continuous, and either side is configured to sit flush against the structural framing members when the construction board assembly 10 is attached to the structural framing members 710. In addition, both sides of the construction board assembly 10 are configured to receive and retain a finish material fastener when the side faces away from the structural framing members 710. In the example, the thermal insulation board 14 of the construction board assembly 10 faces and is secured directly to the structural framing members 710.

The adhesive joins the construction board assembly 10 together with sufficient structural force for the construction board assembly 10 to act as a single structural member and resist delamination when forces are applied to individual layers. For example, the adhesive maintains the union of the construction board assembly 10 and resists delamination when fasteners are driven through the construction board 12 and/or the thermal insulation board 14 from either side to secure the construction board assembly to the structural framing members 710 or finish material.

In addition, the construction board assembly 10 does not need special installation instructions for installation in either orientation or configuration, and the construction board assembly 10 is configured to receive standard fasteners and be installed in any orientation. Accordingly, the construction board assembly 10 simplifies construction of the structure and may reduce labor and material costs for construction.

### Numbered Examples

Example 1. A construction board assembly comprising: a construction board comprising magnesium oxide and including a first face and a second face, wherein the first face of the construction board defines a first uncovered side of the construction board assembly; a thermal insulation board having a first face and a second face, wherein the second face of the thermal insulation board defines a second uncovered side of the construction board assembly, wherein the thermal insulation board comprises a layer of foam insulation having a uniform thickness; and an adhesive between the construction board and the thermal insulation board, wherein the adhesive bonds the first face of the thermal insulation board to the second face of the construction board, wherein the construction board assembly is transportable as a single unit and is configured to attach to structural framing members with the first uncovered side or the second uncovered side facing the structural framing members, wherein the first uncovered side and the second uncovered side are flat and continuous and are arranged to mount to the structural framing members or be exposed as a finish surface.

Example 2. A construction board assembly in accordance with example 1, wherein the adhesive forms a continuous layer extending throughout an entire interface between the construction board and the thermal insulation board.

Example 3. A construction board assembly in accordance with example 1, wherein the adhesive comprises a polymeric adhesive.

Example 4. A construction board assembly in accordance with example 3, wherein the adhesive includes at least one additive selected to modify a property of the polymeric adhesive, wherein the at least one additive is distributed within the polymeric adhesive prior to setting or curing of the polymeric adhesive.

Example 5. A construction board assembly in accordance with example 1, wherein the construction board is configured to receive and retain a finish cladding fastener and the thermal insulation board is configured to sit flush against a framing member when the construction board assembly is attached to the structural framing members with the second uncovered side facing the structural framing members.

Example 6. A construction board assembly in accordance with example 1, wherein the construction board assembly is a sheathing and has a structural load capacity to resist forces and provide structural support for a wall or floor of a building.

Example 7. A construction board assembly in accordance with example 1, wherein the construction board and the thermal insulation board are bonded together to define a monolithic flexural profile and provide a maximum deflection of less than L/360 when transported as a single unit.

Example 8. A construction board assembly in accordance with example 7, wherein the construction board has a density greater than 0.9 g/cm³, wherein the thermal insulation board comprises a rigid closed-cell foam, and wherein the adhesive provides a peel strength sufficient to maintain a monolithic arrangement of the construction board assembly when fasteners are driven through the second uncovered side into the structural framing members.

Example 9. A method of assembling a construction board assembly, the method comprising: providing a construction board comprising magnesium oxide and including a first face and a second face, wherein the first face of the construction board defines a first uncovered side of the construction board assembly; providing a thermal insulation board having a first face and a second face, wherein the second face of the thermal insulation board defines a second uncovered side of the construction board assembly, wherein the thermal insulation board comprises a layer of foam insulation having a uniform thickness; depositing an adhesive on the second face of the construction board or the first face of the thermal insulation board; and positioning at least one of the construction board or the thermal insulation board such that the adhesive is between the construction board and the thermal insulation board, wherein the adhesive bonds the first face of the thermal insulation board to the second face of the construction board to form the construction board assembly, wherein the construction board assembly is transportable as a single unit and is configured to attach to structural framing members with the first uncovered side or the second uncovered side facing the structural framing members, wherein the first uncovered side and the second uncovered side are flat and continuous and are arranged to mount to the structural framing members or be exposed as a finish surface.

Example 10. A method in accordance with example 9, wherein the adhesive is deposited such that the adhesive forms a continuous layer extending throughout an entire interface between the construction board and the thermal insulation board.

Example 11. A method in accordance with example 9, wherein the adhesive includes a polymeric adhesive, and further comprising curing or setting the polymeric adhesive.

Example 12. A method in accordance with example 11, further comprising distributing at least one additive selected to modify a property of the adhesive within the polymeric adhesive prior to curing or setting of the polymeric adhesive.

Example 13. A method in accordance with example 9, further comprising attaching the construction board assembly to the structural framing members with the second uncovered side facing the structural framing members, wherein the construction board is configured to receive and retain a finish cladding fastener and the thermal insulation board is configured to sit flush against a framing member.

Example 14. A method in accordance with example 9, further comprising installing the construction board assembly as a sheathing, wherein the construction board assembly has a structural load capacity to resist forces and provide structural support for a wall or floor of a building.

Example 15. A method in accordance with example 9, further comprising laminating the construction board and the thermal insulation board across an entire interface between the construction board and the thermal insulation board.

Example 16. A method in accordance with example 9, further comprising forming the construction board as a rectangular cuboid sheet, forming the thermal insulation board as a rectangular cuboid sheet, and aligning edges of the construction board with edges of the thermal insulation board.

Example 17. A structure comprising: structural framing members; a construction board assembly attached to the structural framing members, wherein the construction board assembly comprises: a construction board comprising magnesium oxide and including a first face and a second face, wherein the first face of the construction board defines a first side of the construction board assembly; a thermal insulation board having a first face and a second face, wherein the second face of the thermal insulation board defines a second side of the construction board assembly, wherein the thermal insulation board comprises a layer of foam insulation having a uniform thickness; and an adhesive between the construction board and the thermal insulation board, wherein the adhesive bonds the first face of the thermal insulation board to the second face of the construction board, wherein the first side and the second side are flat and continuous and are arranged to mount to the structural framing members or be exposed as a finish surface, wherein the first side of the construction board assembly or the second side of the construction board assembly is mounted directly to the structural framing members.

Example 18. A structure in accordance with example 17, further comprising insulation positioned between or around the structural framing members.

Example 19. A structure in accordance with example 17, wherein the adhesive comprises a polymeric adhesive that forms a continuous layer extending throughout an entire interface between the construction board and the thermal insulation board.

Example 20. A structure in accordance with example 17, wherein the construction board is configured to receive and retain a finish cladding fastener and the thermal insulation board is configured to sit flush against the structural framing members when the construction board assembly is attached to the structural framing members with the second side facing the structural framing members.

Described examples of a construction board assembly reduce or eliminate thermal bridging in panel construction for structures, while still providing desired fastener pullout capacity. Components of the construction board assembly work together to increase the structure's structural integrity, provide a 2-hour minimum fire resistance, protect against termites and other insects, and protect against water or air vapor intrusion. In addition, the construction board assembly is reversible and is configured to receive any type of direct-applied finish cladding on either side. Moreover, the construction board assembly is modular and shippable as a preconfigured and ready-to-install unit. Therefore, the construction board assembly can reduce material and labor costs to assemble and construct a building. Furthermore, the construction board assembly is customizable to provide improved performance properties selected for a specific application.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the disclosure, it is intended that all matter contained in the above description and shown in the accompanying drawings shall be interpreted as illustrative and not in a limiting sense. Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Regardless of whether shown and described in combination or separately, the various features (both structural and methodological) are intended to be selectively included or omitted to produce an embodiment with a particular set of features. In addition, each of the operations described above may be executed in any order. For example, one operation may be performed before another operation. Additionally, one or more of the disclosed operations may be performed simultaneously or substantially simultaneously.

What is claimed is:

1. A construction board assembly comprising:
a construction board comprising magnesium oxide and including a first face and a second face, wherein the first face of the construction board defines a first uncovered side of the construction board assembly;
a thermal insulation board having a first face and a second face, wherein the second face of the thermal insulation board defines a second uncovered side of the construction board assembly, wherein the thermal insulation board comprises a layer of foam insulation having a uniform thickness; and
an adhesive between the construction board and the thermal insulation board, wherein the adhesive bonds the first face of the thermal insulation board to the second face of the construction board,
wherein the construction board assembly is transportable as a single unit and is configured to attach to structural framing members with the first uncovered side or the second uncovered side facing the structural framing members,
wherein the first uncovered side and the second uncovered side are flat and continuous and are arranged to mount to the structural framing members or be exposed as a finish surface.

2. A construction board assembly in accordance with claim 1, wherein the adhesive forms a continuous layer extending throughout an entire interface between the construction board and the thermal insulation board.

3. A construction board assembly in accordance with claim 1, wherein the adhesive comprises a polymeric adhesive.

4. A construction board assembly in accordance with claim 3, wherein the adhesive includes at least one additive selected to modify a property of the polymeric adhesive, wherein the at least one additive is distributed within the polymeric adhesive prior to setting or curing of the polymeric adhesive.

5. A construction board assembly in accordance with claim 1, wherein the construction board is configured to receive and retain a finish cladding fastener and the thermal insulation board is configured to sit flush against a framing member when the construction board assembly is attached to the structural framing members with the second uncovered side facing the structural framing members.

6. A construction board assembly in accordance with claim 1, wherein the construction board assembly is a sheathing and has a structural load capacity to resist forces and provide structural support for a wall or floor of a building.

7. A construction board assembly in accordance with claim 1, wherein the construction board and the thermal insulation board are bonded together to define a monolithic flexural profile and provide a maximum deflection of less than L/360 when transported as a single unit.

8. A construction board assembly in accordance with claim 7, wherein the construction board has a density greater than 0.9 g/cm³, wherein the thermal insulation board comprises a rigid closed-cell foam, and wherein the adhesive provides a peel strength sufficient to maintain a monolithic arrangement of the construction board assembly when fasteners are driven through the second uncovered side into the structural framing members.

9. A method of assembling a construction board assembly, the method comprising:
providing a construction board comprising magnesium oxide and including a first face and a second face, wherein the first face of the construction board defines a first uncovered side of the construction board assembly;
providing a thermal insulation board having a first face and a second face, wherein the second face of the thermal insulation board defines a second uncovered side of the construction board assembly, wherein the thermal insulation board comprises a layer of foam insulation having a uniform thickness;
depositing an adhesive on the second face of the construction board or the first face of the thermal insulation board; and
positioning at least one of the construction board or the thermal insulation board such that the adhesive is between the construction board and the thermal insulation board, wherein the adhesive bonds the first face of the thermal insulation board to the second face of the construction board to form the construction board assembly,
wherein the construction board assembly is transportable as a single unit and is configured to attach to structural framing members with the first uncovered side or the second uncovered side facing the structural framing members,
wherein the first uncovered side and the second uncovered side are flat and continuous and are arranged to mount to the structural framing members or be exposed as a finish surface.

10. A method in accordance with claim 9, wherein the adhesive is deposited such that the adhesive forms a continuous layer extending throughout an entire interface between the construction board and the thermal insulation board.

11. A method in accordance with claim 9, wherein the adhesive includes a polymeric adhesive, and further comprising curing or setting the polymeric adhesive.

12. A method in accordance with claim 11, further comprising distributing at least one additive within the polymeric adhesive prior to curing or setting of the polymeric adhesive.

13. A method in accordance with claim 9, further comprising attaching the construction board assembly to the structural framing members with the second uncovered side facing the structural framing members, wherein the construction board is configured to receive and retain a finish cladding fastener and the thermal insulation board is configured to sit flush against a framing member.

14. A method in accordance with claim 9, further comprising installing the construction board assembly as a sheathing, wherein the construction board assembly has a structural load capacity to resist forces and provide structural support for a wall or floor of a building.

15. A method in accordance with claim 9, further comprising laminating the construction board and the thermal insulation board across an entire interface between the construction board and the thermal insulation board.

16. A method in accordance with claim 9, further comprising:
forming the construction board as a rectangular cuboid sheet;
forming the thermal insulation board as a rectangular cuboid sheet; and
aligning edges of the construction board with edges of the thermal insulation board.

17. A structure comprising:
structural framing members;
a construction board assembly attached to the structural framing members, wherein the construction board assembly comprises:
a construction board comprising magnesium oxide and including a first face and a second face, wherein the first face of the construction board defines a first side of the construction board assembly;
a thermal insulation board having a first face and a second face, wherein the second face of the thermal insulation board defines a second side of the construction board assembly, wherein the thermal insulation board comprises a layer of foam insulation having a uniform thickness; and
an adhesive between the construction board and the thermal insulation board, wherein the adhesive bonds the first face of the thermal insulation board to the second face of the construction board,
wherein the first side and the second side are flat and continuous and are arranged to mount to the structural framing members or be exposed as a finish surface,
wherein the first side of the construction board assembly or the second side of the construction board assembly is mounted directly to the structural framing members.

18. A structure in accordance with claim 17, further comprising insulation positioned between or around the structural framing members.

19. A structure in accordance with claim 17, wherein the adhesive comprises a polymeric adhesive that forms a continuous layer extending throughout an entire interface between the construction board and the thermal insulation board.

20. A structure in accordance with claim 17, wherein the construction board is configured to receive and retain a finish cladding fastener and the thermal insulation board is configured to sit flush against the structural framing members when the construction board assembly is attached to the structural framing members with the second side facing the structural framing members.
